(19) United States
(12) Patent Application Publication
(10) Pub. No.: US 2025/0301331 A1
(43) Pub. Date: Sep. 25, 2025

(54) Automotive Telematics Privacy Device

(71) Applicants: Matthew Sidney Geouge, Hendersonville, NC (US); Caroline O. Jackson, Hendersonville, NC (US)

(72) Inventors: Matthew Sidney Geouge, Hendersonville, NC (US); Caroline O. Jackson, Hendersonville, NC (US)

(21) Appl. No.: 19/090,140

(22) Filed: Mar. 25, 2025

Related U.S. Application Data
(60) Provisional application No. 63/569,557, filed on Mar. 25, 2024.

(51) Int. Cl. H04W 12/79; H04M 1/72409; H04W 12/06; H04W 12/121

(52) U.S. Cl. CPC H04W 12/79; H04M 1/724098; H04W 12/06; H04W 12/121

(57) ABSTRACT

A system, method and device for safeguarding privacy in vehicles, comprising a processor, memory, radio frequency (RF) switches, electromechanical relays, and a user interface. The system is configured to perform steps including receiving a control input to activate a privacy mode, generating control signals to selectively disconnect RF components, such as GPS antennas and telematics modems, and electrical components, such as microphones and cameras, using RF switches and relays, respectively. The system verifies the operational status of the disconnected components and provides feedback to the user confirming activation of the privacy mode. The system may further include features for dynamic monitoring, secure authentication, user-specific profiles, and predictive activation based on contextual data such as location or connectivity. These features enable automated and tailored privacy protection, ensuring the prevention of unauthorized data transmission or collection within the vehicle.

### FIELD OF THE INVENTION

The present invention relates generally to electronic devices for automobiles. More specifically, the present invention relates to an accessory designed to selectively disconnect or isolate certain electrical and radio frequency functions within a vehicle to safeguard data privacy and personal privacy.

### BACKGROUND OF THE INVENTION

Modern vehicles are increasingly equipped with a host of electronic devices and systems that significantly enhance connectivity, functionality, and safety. Features such as GPS navigation systems, satellite radios, and telemetric systems provide real-time location tracking, entertainment options, and remote monitoring capabilities, while integrated cameras and microphones enable advanced functionalities such as parking assistance, voice recognition, and hands-free communication. These advancements are emblematic of the broader trend of automobiles becoming integral parts of an interconnected ecosystem fueled by the Internet of Things (IoT).

However, these embedded technologies also introduce substantial data privacy challenges. Advanced telemetric systems, in particular, can transmit sensitive data, including vehicle location, travel patterns, and occupant interactions, to external servers for analysis or monitoring. Similarly, integrated microphones and cameras can inadvertently compromise the privacy of conversations or visual data within the vehicle cabin. The ever-increasing connectivity of vehicles has widened the potential vectors for data breaches and unauthorized access, creating significant vulnerabilities for vehicle occupants.

A notable concern is the exploitation of weaknesses in vehicles' radio frequency (RF) communication systems. These systems connect to GPS antennas, satellite radios, and telematic modems, enabling bi-directional data flow between vehicles and external networks. While providing crucial services such as real-time traffic updates and emergency assistance, these communication channels could be misused to track occupants' movements or intercept sensitive transmissions. Moreover, vulnerabilities within these systems are susceptible to exploitation by malicious actors, potentially leading to unauthorized intrusions and data leakage, despite regulatory standards.

The challenge extends beyond RF systems to other electronic features integrated within vehicles. Features such as intelligent driver assistance systems, proximity sensors, and cabin cameras, while optimizing operational safety and convenience, can inadvertently collect and store sensitive audio-visual data, such as conversations and recordings of the cabin environment. With limited user-level control over their activation, these systems present ongoing risks to occupants' privacy.

The rise of IoT-enabled vehicles has compounded these privacy risks. Modern vehicles are no longer standalone machines but interconnected nodes in larger networks. This connectivity amplifies the vulnerability of vehicles to cyberattacks, where unauthorized connection to critical components may compromise sensitive user data. Threat scenarios include unauthorized GPS tracking, interception of communications, and breaches through vehicle-centered networks.

Additionally, the global regulatory landscape addressing data privacy within the automotive industry is still fragmented and evolving. While data protection regulations like GDPR provide a framework for privacy safeguards, they fall short in addressing the unique risks associated with automotive technologies. This regulatory gap leaves individuals exposed to privacy intrusions, with limited recourse to mitigate or manage threats.

In response to these growing privacy concerns, there is a clear demand for user-directed technologies that provide granular control over electronic and RF functionalities within a vehicle. Such solutions can selectively disconnect or isolate GPS antennas, telemetric modems, microphones, cameras, and other systems, ensuring that private data remains under the control of the vehicle occupants. By incorporating advanced systems such as RF switches and electromechanical relays, integrated into a seamless user interface, the invention proposed herein addresses a critical technological gap. It not only mitigates privacy risks associated with data collection but also empowers vehicle occupants to customize their privacy settings dynamically based on contextual or environmental factors.

Thus, the present invention serves as a practical response to the rising demand for better consumer control over data privacy in modern vehicles, offering a scalable and versatile solution adaptable across various automotive platforms. The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention provides a system, method, and device designed as an accessory for automobiles to enable the selective disconnection or isolation of specific electrical and radio frequency (RF) components within a vehicle for the purpose of safeguarding data privacy and personal privacy. By offering targeted control over systems that collect, transmit, or receive data, the present invention empowers users to mitigate privacy risks associated with modern connected vehicles, improving security and personalization for vehicle occupants.

The system of the present invention includes an electronic circuit board and a wiring harness, integrated into the vehicle's existing infrastructure, and is designed to operate seamlessly with various automotive electronic systems. The system employs RF switches and electromechanical relays, which are configured to provide control over both RF and electrical components of the vehicle. The RF switches isolate or disconnect RF-related systems such as GPS antennas, satellite radios, and telematics modems, thereby preventing the transmission and reception of RF signals. This prevents unauthorized tracking, real-time data capture, and communication between the vehicle and external networks. In addition, the electromechanical relays isolate electrical systems, including microphones, cameras, and cabin sensors, to prevent the collection and transmission of audio and visual data within the vehicle.

The method provided by the present invention involves selectively disconnecting or isolating these systems through either a manual operation by the user or an automated process triggered by environmental or contextual inputs. A user interface or control module located within the vehicle cabin can allow occupants to easily toggle the functionality of the systems to meet their privacy preferences. Alternatively, the system of the present invention may rely on preconfigured settings or data from external inputs, such as vehicle location or network activity, to activate privacy modes dynamically without user intervention.

The device of the present invention comprises the electronic circuit board equipped with RF switches and electromechanical relays to perform the above-described functions. The device integrates directly with the vehicle's wiring harness and electrical systems, allowing for modular and scalable installation across a variety of vehicle platforms and configurations. The present invention is adaptable to vehicles of different types and is designed to accommodate the evolving requirements of connected automotive systems while addressing the growing concerns of privacy-conscious users.

The present invention thus provides a comprehensive solution to address privacy risks posed by modern automotive systems, particularly connected and IoT-enabled vehicles that continuously transmit, receive, and store sensitive user data. By disconnecting or isolating both RF and electrical systems, the present invention prevents unauthorized access to personal information or data collection through features such as GPS tracking devices, telematics, microphones, or cameras. This not only mitigates privacy intrusions but also addresses gaps in the current regulatory framework surrounding data collection and protection in modern automobiles.

The present invention, by providing a system, method, and device for selectively isolating sensitive components, serves as a robust and proactive solution for safeguarding privacy in connected vehicles and enables a customizable and effective means of maintaining data security for vehicle occupants.

### BRIEF DESCRIPTION OF THE DRAWINGS

FIG. 1 illustrates an embodiment of the present invention as implemented within a vehicle, showing the interaction of the system of the present invention with various vehicle components.

FIG. 2 illustrates a flow diagram showing one embodiment of the method of the present invention.

FIG. 3 illustrates a schematic diagram showing one embodiment of the system components of the present invention.

FIG. 4 illustrates an embodiment of the electronic circuit board of the present invention.

FIG. 5 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present invention offers a novel and effective solution for safeguarding personal and data privacy in automobiles. By allowing the selective disconnection of specific electrical and radio frequency functions, it empowers vehicle owners to take control of their privacy in an increasingly connected world.

The present invention can be designed as an accessory for automobiles, aimed at enhancing data privacy and personal privacy. The present invention achieves this by selectively disconnecting or isolating certain electrical and radio frequency functions within the vehicle.

The device of the present invention may feature an electronic circuit board and a wiring harness, employing radio frequency switches and electromechanical relays to disconnect features such as GPS antennas, satellite radio antennas, telemetrics modems, microphones, and cameras.

The present invention provides a device or a system that can be considered as an auxiliary apparatus for automotive vehicles 20, aiming to substantially enhance the data privacy and personal privacy of vehicle occupants.

The present invention utilizes selective disconnection or isolation of certain electrical and radio frequency (RF) functionalities inherent to the vehicle's operational systems.

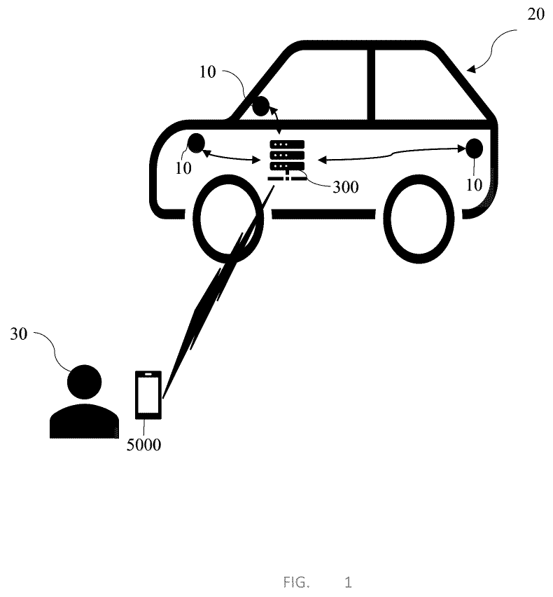

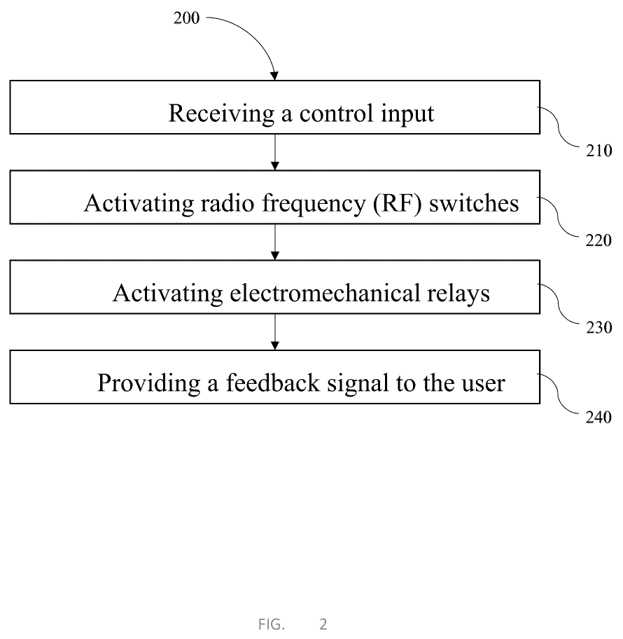

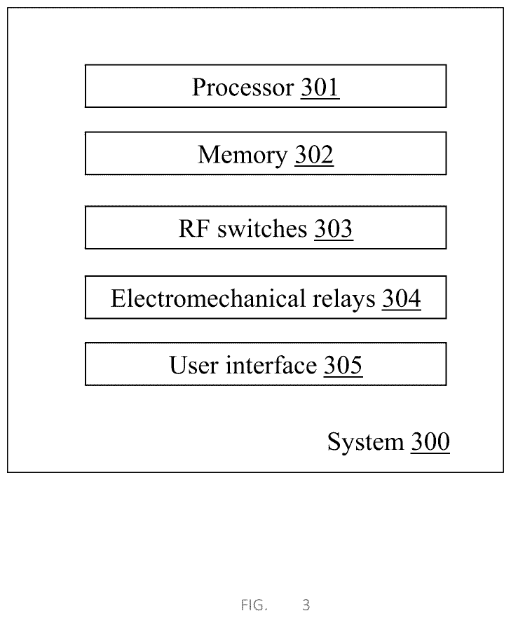

In general, the system disclosed herein may be configured for operation as shown in the figures, including FIG. 1 and FIG. 2. For example, FIG. 1 and FIG. 2 depict how vehicle occupants can interact with an electronic privacy control system of the present invention via a user interface 305. In FIG. 3, the electronic circuit board is illustrated as the central processing hub, equipped with RF switches and electromechanical relays, responsible for selectively disconnecting RF and electrical components to safeguard user privacy. The system may disconnect, for instance, GPS antennas, satellite radio antennas, microphones, and cameras. The wiring harness may be utilized for seamless integration of these components into the vehicle's electrical framework.

In addition, contextual or environmental data, such as vehicle location, travel patterns, and network connectivity, can be automatically analyzed to activate privacy modes, as illustrated in FIG. 1 or FIG. 2.

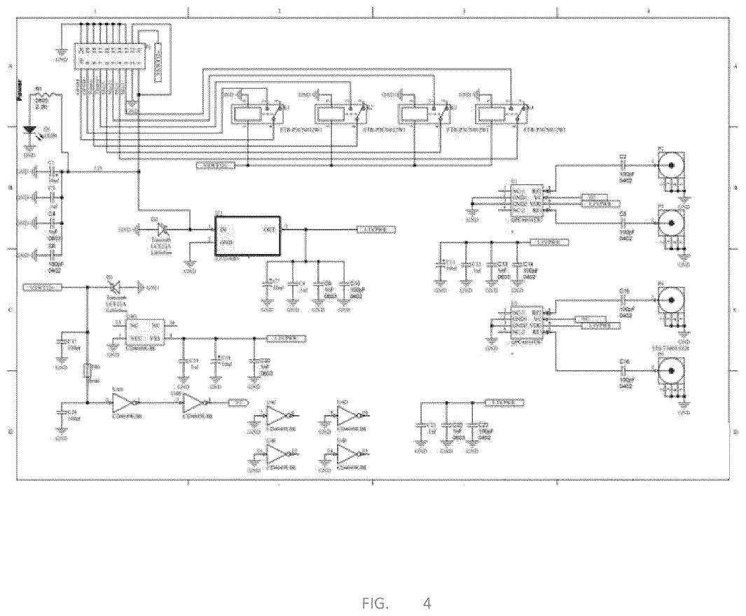

While FIG. 4 may detail the circuit board's components, adaptations or modifications such as incorporating additional electronic components or adjusting the wiring harness configuration for compatibility with various automotive models are within the scope of the invention. Accordingly, the claims define the invention's scope, encompassing all equivalents and variations supported by the accompanying figures and descriptions.

In preferred embodiment, the present invention comprises one or more electronic circuit boards and one or more wiring harnesses which work in tandem to effectuate the disconnection or isolation of specified RF and electrical features within the vehicle 20.

The electronic circuit board, shown in FIG. 3, can be the nerve center of the device, outfitted with an array of radio frequency switches and electromechanical relays.

In one embodiment, the radio frequency switches can be strategically employed to sever the connection to RF functionalities such as, but not limited to, GPS antennas, satellite radio antennas, and telemetrics modems.

This disconnection may impede the transmission and reception of RF signals pertinent to these functions, thereby curtailing the potential for unauthorized data collection and transmission.

Simultaneously, the electromechanical relays integrated into the circuit board can be designed to disconnect other electrical features within the vehicle. This includes, inter alia, microphones and cameras. By severing these connections, the present invention precludes the collection and subsequent dissemination of audio and visual information, further bolstering the privacy safeguards afforded to the vehicle's occupants.

The wiring harness may be any wiring harness known in the art and is configured to function as the conduit through which the electronic circuit board interfaces with the vehicle's existing electrical and radio frequency (RF) systems. It can be configured to ensure seamless integration with the vehicle's architecture, facilitating the efficient disconnection or isolation of the targeted features upon activation of the device.

In use, the operation of the present invention, electronic privacy control device, of is predicated on the selective activation of the radio frequency switches and electromechanical relays embedded within the electronic circuit board.

For example, as shown in FIG. 1 and FIG. 2, vehicle occupants can initiate this activation through a user interface 305, which may be embodied as a physical control panel within the vehicle 20 or a digital interface accessible via a smartphone application or any computing device.

Upon activation, the RF switches and electromechanical relays engage to disconnect the specified RF and electrical features, thereby instantaneously enhancing the privacy protections within the vehicle.

RF switches are designed to work with RF receivers, antennas, or other RF components to route or disconnect radio frequency signals. They are specifically used for managing and controlling the flow of RF signals between components, such as enabling or disabling communication with a GPS antenna, telematics system, or any RF transmission/reception module in the vehicle 20.

On the other hand, electromechanical relays are typically used to control electrical components or circuits. They can work with sensors 10 by disconnecting or isolating sensor-related electrical components, such as microphones, cameras, or actuators, preventing data collection or operation.

The installation of the electronic privacy control device (or system 300) of the present invention can be straightforward, allowing for retrofitting into existing vehicles with minimal modification required. The device is designed to be universally compatible with a wide array of automotive makes and models, ensuring broad applicability and ease of adoption.

In preferred embodiment, the present invention provides a system 300 and method 200 for following steps: Receiving, through a user interface 305, a control input indicating a selected privacy mode to be activated at 210; Activating one or more radio frequency (RF) switches coupled to the vehicle's electronic systems to disconnect RF components, including but not limited to a GPS antenna, satellite radio antenna, and telematics modem, thereby preventing transmission and reception of RF signals at 220; Activating one or more electromechanical relays coupled to the vehicle's electronic systems to disconnect electrical components, including but not limited to microphones and cameras, thereby preventing the collection and transmission of audio and visual data at 230; and Providing a feedback signal to the user 30, confirming the successful disconnection of the specified RF and electrical components at 240.

In some embodiments, the present invention may further comprise monitoring RF signal activities and automatically activating the one or more RF switches to disconnect the RF components upon detection of anomalous activity or unauthorized transmissions.

In some embodiments, the step of receiving the control input may further comprise requiring a secure authentication method, including at least one of a password, biometric scan, or encrypted communication, to authorize activation of the privacy mode.

In some embodiments, the present invention may further include storing and retrieving user-specific privacy profiles, wherein each privacy profile includes pre-configured instructions to disconnect one or more of the RF and electrical components according to the preferences of the identified user 30.

In some embodiments, the present invention may further comprise the step of analyzing contextual and environmental data, including but not limited to vehicle location, travel patterns, or connectivity, and automatically activating the privacy mode when predefined thresholds or conditions are met. This feature builds on the preferred embodiment described above by adding an automated alternative for triggering privacy activation, removing the need for a manual request in certain situations. The system 300 analyzes contextual and environmental data (e.g., location, travel patterns, network activity) and decides to activate the privacy mode automatically when a predefined condition or threshold is met. For example, If the vehicle 20 enters a sensitive area (such as near a predefined location like a workplace), the system 300 could automatically disconnect GPS and cameras without requiring manual input.

In some embodiments, the providing a feedback signal may comprises stepwise feedback for each component being disconnected, including visual or audio indicators to confirm the disconnection status of RF and electrical components.

In some embodiments, the present invention may further comprise providing a time-limited privacy activation, wherein RF and electrical components are automatically reconnected after a predetermined duration or upon receipt of a second control input.

The system 300 of the present invention may comprise the components described herein, including but not limited to a processor 301, memory 302, RF switches 303, electromechanical relays 304, and a user interface 305, and is configured to execute the method 200 disclosed herein. As in one embodiment depicted in FIG. 3, the system 300 may include the aforementioned components.

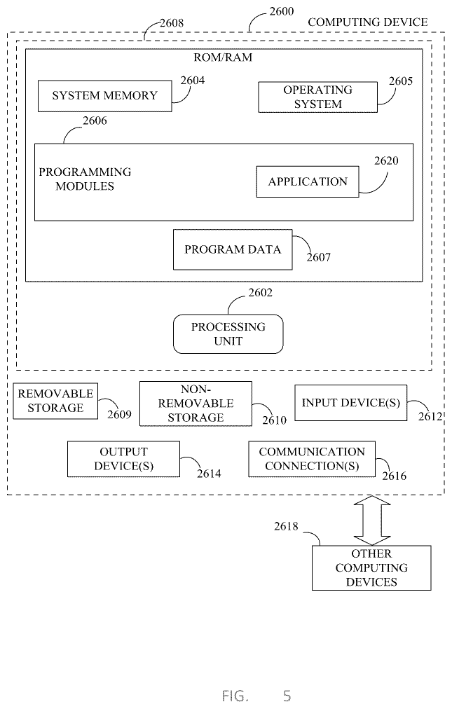

With reference to FIG. 5, a system consistent with an embodiment of the disclosure may include a computing device computing device 5000. In a basic configuration, computing device 5000 may include at least one processing unit 5002 and a system memory 5004. Depending on the configuration and type of computing device, system memory 5004 may comprise, but is not limited to, volatile (e.g., random-access memory (RAM)), non-volatile (e.g., read-only memory (ROM)), flash memory, or any combination. System memory 5004 may include operating system 5005, one or more programming modules 5006, and may include a program data 5007. Operating system 5005, for example, may be suitable for controlling computing device 5000's operation. In one embodiment, programming modules 5006 may include image-processing modules, machine learning modules, etc. Furthermore, embodiments of the disclosure may be practiced in conjunction with a graphics library, other operating systems, or any other application program and are not limited to any particular application or system. This basic configuration is illustrated in FIG. 5 by those components within a dashed line 5008.

Computing device 5000 may have additional features or functionality. For example, computing device 5000 may also include additional data storage devices (removable and/or non-removable), such as, for example, magnetic disks, optical disks, or tape. Such additional storage is illustrated in FIG. 5 by a removable storage 5009 and a non-removable storage 5010. Computer storage media may include volatile and non-volatile, removable and non-removable media implemented in any method or technology for storage of information, such as computer-readable instructions, data structures, program modules, or other data. System memory 5004, removable storage 5009, and non-removable storage 5010 are all computer storage media examples (i.e., memory storage).

Computer storage media may include, but are not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium that can be used to store information and that can be accessed by computing device 5000. Any such computer storage media may be part of device 5000.

Computing device 5000 may also have input device(s) 5012, such as a keyboard, a mouse, a pen, a sound input device, a touch input device, a location sensor, a camera, a biometric sensor, etc. Output device(s) 5014, such as a display, speakers, a printer, etc., may also be included. The aforementioned devices are examples, and others may be used.

Computing device 5000 may also contain a communication connection 5016 that may allow device 5000 to communicate with other computing devices 5018, such as over a network in a distributed computing environment, for example, an intranet or the Internet. Communication connection 5016 is one example of communication media.

Communication media may typically be embodied by computer-readable instructions, data structures, program modules, or other data in a modulated data signal, such as a carrier wave or other transport mechanism, and include any information delivery media. The term “modulated data signal” may describe a signal that has one or more characteristics set or changed in such a manner as to encode information in the signal. By way of example, and not limitation, communication media may include wired media, such as a wired network or direct-wired connection, and wireless media, such as acoustic, radio frequency (RF), infrared, and other wireless media. The term “computer-readable media” as used herein may include both storage media and communication media.

As stated above, a number of program modules and data files may be stored in system memory 5004, including operating system 5005. While executing on processing unit 5002, programming modules 5006 may perform processes including, for example, one or more stages of methods, algorithms, systems, applications, servers, and databases as described above. The aforementioned process is an example, and processing unit 5002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage medium readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.).

In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list) may include the following: an electrical connection having one or more wires, a portable computer diskette, random-access memory (RAM), read-only memory (ROM), erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. Method comprising steps of:
Receiving, through a user interface, a control input indicating a selected privacy mode to be activated;
Activating one or more radio frequency (RF) switches to disconnect RF components;
Activating one or more electromechanical relays to disconnect electrical components; and
Providing a feedback signal to a user, confirming the successful disconnection of the electrical components.

2. The method of claim 1, further comprising monitoring RF signal activities and automatically activating the one or more RF switches to disconnect RF components and electrical components upon detection of anomalous activity or unauthorized transmissions.

3. The method of claim 2, wherein receiving the control input further comprises requiring a secure authentication method, including at least one of a password, biometric scan, or encrypted communication, to authorize activation of the selected privacy mode.

4. The method of claim 2, further comprising:
storing and retrieving user-specific privacy profiles, wherein each user-specific privacy profile includes pre-configured instructions to disconnect one or more of the RF and electrical components according to the preferences of the identified user.

5. The method of claim 1, further comprising a step of analyzing contextual and environmental data, and automatically activating the selected privacy mode when predefined thresholds or conditions are met.

6. The method of claim 5, wherein providing the feedback signal comprises stepwise feedback for each component being disconnected, including visual or audio indicators to confirm a disconnection status of RF and electrical components.

7. The method of claim 5, further comprising providing a time-limited privacy activation, wherein the RF and electrical components are automatically reconnected after a predetermined duration or upon receipt of a second control input.

8. Method comprising steps of:
Receiving, through a user interface, a control input indicating a selected privacy mode to be activated;
Activating one or more radio frequency (RF) switches coupled to vehicle's electronic systems to disconnect RF components, thereby preventing transmission and reception of RF signals;
Activating one or more electromechanical relays coupled to the vehicle's electronic systems to disconnect electrical components, thereby preventing the collection and transmission of audio and visual data; and
Providing a feedback signal to a user, confirming a successful disconnection of the RF and electrical components; wherein the feedback signal includes stepwise feedback for each component being disconnected, including visual or audio indicators to confirm disconnection status of the RF and electrical components.

9. The method of claim 8, further comprising monitoring RF signal activities and automatically activating the one or more RF switches to disconnect the RF components upon detection of anomalous activity or unauthorized transmissions.

10. The method of claim 8, wherein receiving the control input further comprises requiring a secure authentication method, including at least one of a password, biometric scan, or encrypted communication, to authorize activation of the privacy mode.

11. The method of claim 10, further comprising:
storing and retrieving user-specific privacy profiles, wherein each privacy profile includes pre-configured instructions to disconnect one or more of the RF and electrical components according to preferences of the user.

12. The method of claim 8, further comprising a step of analyzing contextual and environmental data, and automatically activating the selected privacy mode when predefined thresholds or conditions are met.

13. The method of claim 12, further comprising providing a time-limited privacy activation, wherein the RF and electrical components are automatically reconnected after a predetermined duration or upon receipt of a second control input.

14. A system comprising a processor, a memory, RF switches, electromechanical relays, and a user interface, the system being configured to perform the steps of:
Receiving, through a user interface, a control input indicating a selected privacy mode to be activated;
Activating one or more radio frequency (RF) switches coupled to a vehicle's electronic systems to disconnect RF components, thereby preventing transmission and reception of RF signals;
Activating one or more electromechanical relays coupled to the vehicle's electronic systems to disconnect electrical components, thereby preventing collection and transmission of audio and visual data; and
Providing a feedback signal to a user, confirming successful disconnection of the RF and electrical components.

15. The method of claim 14, further comprising monitoring RF signal activities and automatically activating the one or more RF switches to disconnect the RF components upon detection of anomalous activity or unauthorized transmissions.

16. The method of claim 14, wherein receiving the control input further comprises requiring a secure authentication method, including at least one of a password, biometric scan, or encrypted communication, to authorize activation of the selected privacy mode.

17. The method of claim 16, further comprising:
storing and retrieving user-specific privacy profiles, wherein each privacy profile includes pre-configured instructions to disconnect one or more of the RF and electrical components according to preferences of the user.

18. The method of claim 17, further comprising a step of analyzing contextual and environmental data, and automatically activating the selected privacy mode when predefined thresholds or conditions are met.

19. The method of claim 14, wherein providing the feedback signal comprises stepwise feedback for each component being disconnected, including visual or audio indicators to confirm disconnection status of the RF and electrical components.

20. The method of claim 14, further comprising providing a time-limited privacy activation, wherein the RF and electrical components are automatically reconnected after a predetermined duration or upon receipt of a second control input.
